(19) United States
(12) Patent Application Publication
(10) Pub. No.: US 2004/0215802 A1
(43) Pub. Date: Oct. 28, 2004

(54) System and method for resource-efficient live media streaming to heterogeneous clients

(76) Inventors: Lisa Amini, Yorktown Heights, NY (US); Pascal Frossard, Bulle (CH); Chitra Venkatramani, Roslyn Heights, NY (US); Olivier Verscheure, Harrison, NY (US); Peter Westerink, Ossining, NY (US)

Correspondence Address: F. CHAU & ASSOCIATES, LLP, Suite 501, 1900 Hempstead Turnpike, East Meadow, NY, 11554, US

(21) Appl. No.: 10/409,303

(22) Filed: Apr. 8, 2003

(51) Int. Cl. G06F 15/16

(52) U.S. Cl. 709/231

(57) ABSTRACT

A resource-efficient live streaming system includes a broadcaster and a streaming server. The broadcaster receives a live feed and broadcasts a media stream to the streaming server containing several descriptions of the live feed along with control information. The broadcaster includes a stream thinner that implements a pruning algorithm. If descriptions from different streams are similar enough, one or more of them may be discarded without penalizing the quality of service perceived by the receivers. The streaming server assembles compressed data units into streams according to the control information from the broadcaster. The streaming server may also gather client feedback in order to estimate the status of the transmission channels and forwards the information to the broadcaster. The streaming server builds and streams media information to clients according to user preferences and receiver capabilities.

### BACKGROUND OF THE INVENTION

1. Field of the Invention

The present invention relates generally to management of network resources, and more particularly, to techniques for providing resource-efficient live media streaming to heterogeneous clients.

2. Background of the Invention

Events such as sporting games, musical performances, and news reports are often made available via live media streaming. New applications for live media streaming, such as distance learning and tele-surgery, continue to emerge.

Although conventional live media streaming is useful, there exist a number of shortcomings. Currently, methods for live stream delivery have substantial bandwidth requirements. When bandwidth nears or reaches capacity it is common for data to be discarded. This often causes the information received to be of poor quality.

Various techniques for dealing with such problems have been proposed. For example, Zhang et al., “Efficient Selective Frame Discard Algorithms for Stored Video Delivery Across Resource Constrained Networks,” Proceedings of the IEEE INFOCOM Conference, Vol. 2, pp. 472-479. 1999, discloses an optimal frame discard scheme, which minimizes the number of frames to be skipped, for given bandwidth and buffer size. However, this scheme simply discards frames and does not provide any way to replace them.

McCanne et al., “Low-complexity Video Coding for Receiver-driven Layered Multicast,” IEEE Journal on Selected Areas in Communication, 15(6):983-1001, August 1997, discloses a transport protocol based on RTP (Real Time Protocol), in which clients can subscribe to different layers (each one increasing the quality, but also the rate). The video layers are sent over different multicast groups, and the receiver decides to which groups it wants to subscribe, based on its available bandwidth. However, this scheme can rapidly result in bandwidth overflow at the server and is overly complex and costly to implement.

Other methods include transcoding within intermediate nodes to adapt the stream to the downstream available bandwidth, but such methods pose high computational requirements.

### SUMMARY OF THE INVENTION

According to various exemplary embodiments of the present invention, resource-efficient live streaming systems and methods are provided. The exemplary resource-efficient live streaming systems and methods include a broadcaster and a streaming server. The broadcaster receives a live feed and broadcasts a media stream containing several descriptions of the live feed along with control information.

These descriptions have different characteristics in terms of bit-rate or structure, in order to cover the requirements of the different clients. The descriptions are basically a series of compressed data units (e.g., video frames). The different encoding parameters generate several compressed descriptions of the original data units. In general, the clients receive one description for each data unit, but these descriptions can come from different compressed bitstreams.

A stream thinner can decide to send all the descriptions, one complete description and parts of the others, or any combination it will determine as being appropriate to optimally serve all the clients. The stream thinner implements a pruning algorithm based on the media content, and on the feedback it receives from the network about the actual infrastructure configuration and client capabilities. If descriptions from different streams are similar enough, one or more of them will be discarded without penalizing the quality of service perceived by the receivers.

The streaming server receives the media stream and builds and streams media information to clients according to user preferences and receiver capabilities. The streaming server assembles compressed data units into streams according to the control information. In various embodiments of the present invention, the streaming server also gathers client feedback in order to estimate the status of the transmission channels and forwards the information to the broadcaster.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 shows an exemplary resource-efficient live streaming system;

FIG. 2 shows an exemplary transmission schedule for the resource-efficient live streaming system operating in unicast mode;

FIG. 3 shows an exemplary multicast version of the resource-efficient live streaming system;

FIG. 4 shows a flow diagram for an exemplary embodiment of the resource-efficient live streaming system;

FIG. 5 shows an example of a packet generated by a TCP multiplexer; and

FIG. 6 shows an example of control packet generation.

### DESCRIPTION OF PREFERRED EMBODIMENTS

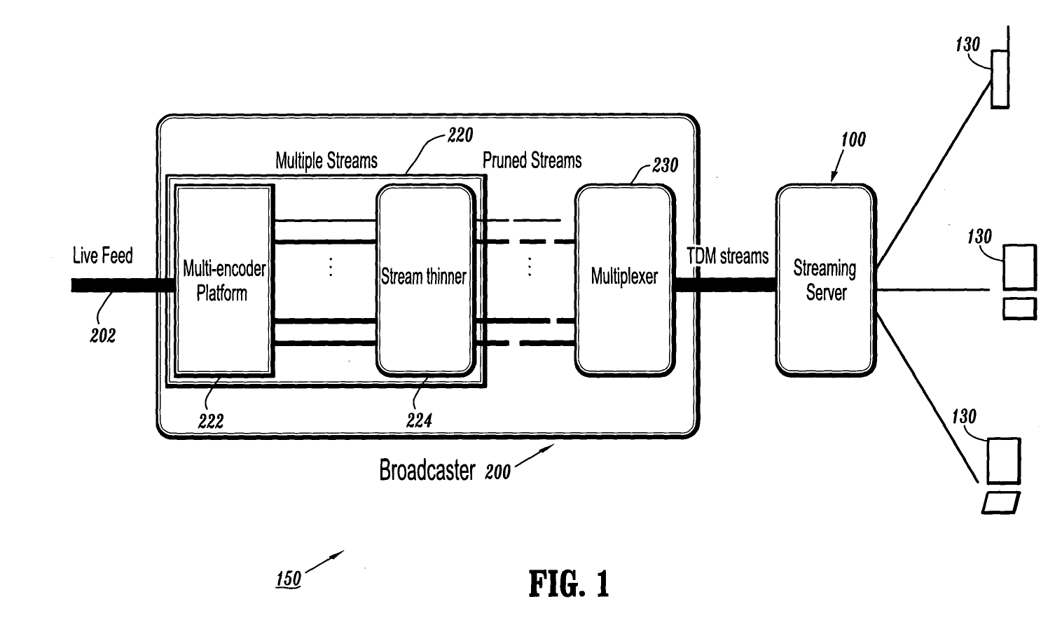

Referring to FIG. 1, an exemplary resource-efficient live streaming system 150 is illustrated. The exemplary resource-efficient live streaming system 150 includes a streaming server 100 and a broadcaster 200. The broadcaster 200 receives a live feed 202 and broadcasts a media stream containing several compressed descriptions of the live feed 202 along with control information.

The streaming server 100 receives the media stream and builds and streams media information to clients 130 according to user preferences and receiver capabilities. The streaming server 100 assembles compressed data units into streams according to the control information from the broadcaster 200. In various embodiments of the present invention, the streaming server also gathers client feedback in order to estimate the status of the transmission channels and forwards the information to the broadcaster 200.

As depicted in FIG. 1, the broadcaster 200 includes a multiple output encoder 220 and a multiplexer 230. The multiple output encoder 220 includes a multi-encoder platform 222 and a stream thinner 224. The live feed 202 is input to the multi-encoder platform 222, which outputs several bitstreams of the source signal. These bitstreams have different characteristics in terms of bit-rate or structure (e.g., encoding modes), in order to cover the requirements of the different clients 130. The bitstreams are basically a series of compressed data units (e.g., video frames). The different encoding parameters generate several compressed descriptions of the original data units. In general, the clients 130 receive one description for each data unit, but these descriptions can come from different compressed bitstreams. The number of descriptions can also vary depending on the transmission conditions, and data units can even be skipped if the available bandwidth becomes too small.

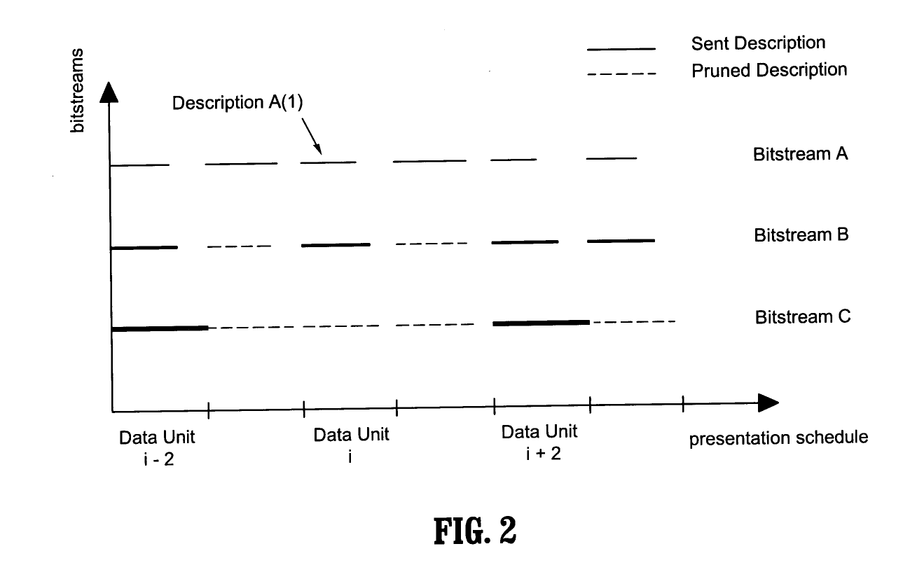

The encoded bitstreams are sent to a stream thinner 220, which dynamically decides which descriptions will be sent over the network to the clients, as represented in FIG. 2. The stream thinner 220 can decide to send all the bitstreams, one complete bitstream and parts of the others, or any combination it will determine as being appropriate to optimally serve all the receivers. The stream thinner 220 implements a pruning algorithm based on the media content, and on the feedback it receives from the network about the actual infrastructure configuration and client capabilities. Basically, if descriptions from different streams are similar enough, one or more of them will be discarded without penalizing the quality of service perceived by the receivers.

In most cases, the clients 130 are connected to streaming proxy servers and not directly to the stream thinner. The stream thinner 220, which can act as a streaming server too, uses the multiplexer 230 to multiplex the descriptions on a unicast-type connection to one or several proxy servers (not shown). Similar to time-division multiplexing (TDM) methods, it sends the data units required by the proxy server according to their presentation deadline, in order to keep the playback delay at a minimal value, while optimizing the quality of service for the clients 130. Based on the scenario represented in FIG. 2, the transmission schedule in the unicast scenario is given by:

{ . . . , A(i-2), B(i-2), C(i-2), A(i-1), A(i), B(i), . . . }.

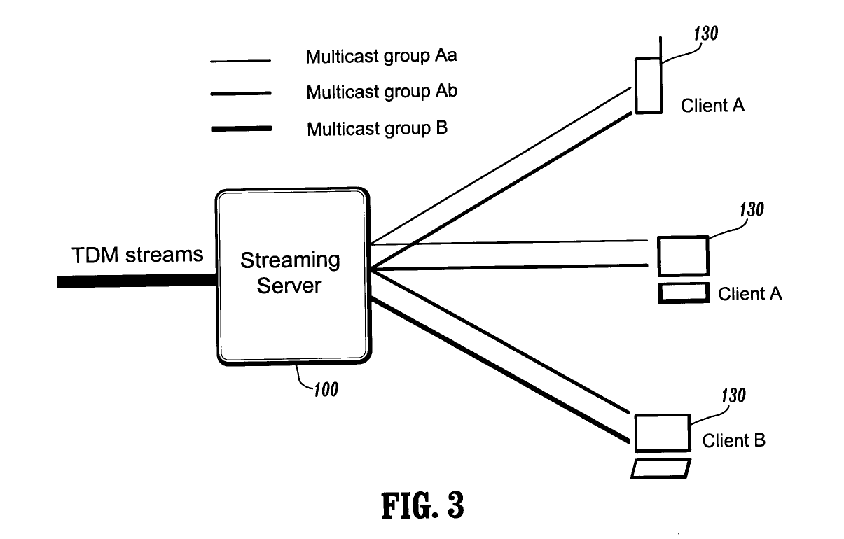

Referring to FIG. 3, an exemplary multicast of a media stream is illustrated. As depicted, clients 130 with similar capabilities are grouped into two clusters, A and B. Clients in cluster A subscribe to multicast groups Aa and Ab, while clients in cluster B subscribe to multicast groups Ab and B. Although FIG. 2 shows two clusters, A and B, it should be appreciated that additional clusters could also be used.

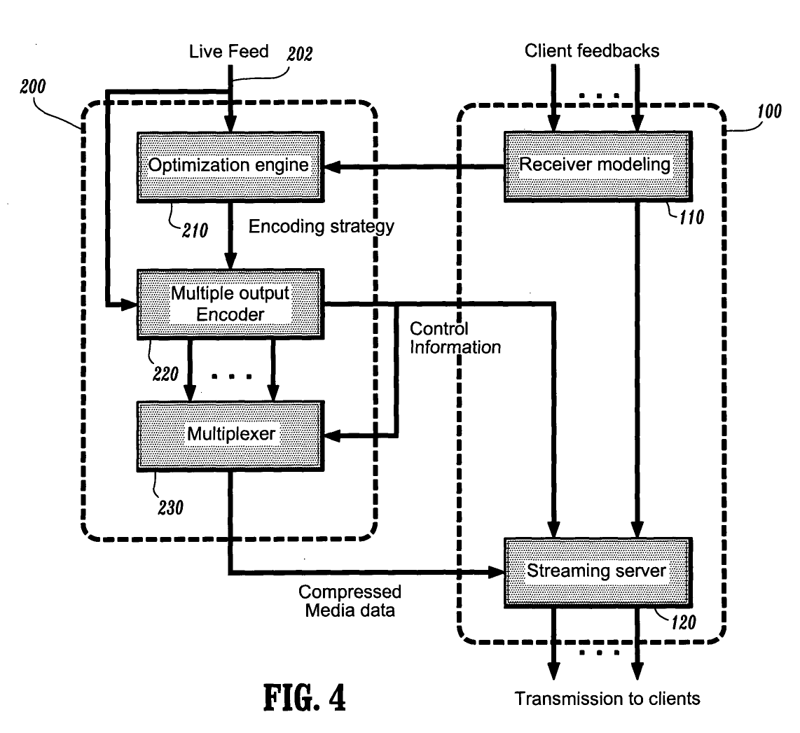

Consider only streams A and B from FIG. 2. Stream Ab in FIG. 3 represents the descriptions common to both streams A and B. When Internet Protocol (IP) multicast is available, each of the descriptions Aa, Ab and B, is efficiently distributed over a multicast group, as represented in FIG. 3. The number of groups, and the distribution of the different descriptions, are driven by the network infrastructure, and the receiver requirements. The receivers subscribe to possibly several multicast groups in order to receive the complete media information, i.e., all the data units of the media stream. For example, in the case where a client receives a stream where some descriptions have been pruned, it subscribes to the group where the main stream is sent, and to the group corresponding to the descriptions replacing the pruned ones in the main stream (see FIG. 4).

The stream builder 100 ensures that clients will obtain all the data units as determined by an optimization algorithm. It forms client streams, and sends them via an IP multicast, an application-layer multicast or a pure unicast session, depending on the available network infrastructure. The system and method disclosed herein allows for important savings in bandwidth, since it avoids the duplication of very similar descriptions. It allows service of a heterogeneous set of clients with a minimal bandwidth consumption.

An additional advantage is that the adaptive stream delivery is performed with very low complexity in the network nodes. The intermediate nodes generally only have to multiplex the different descriptions, or form different multicast groups. The complexity of such processes is very simple compared to transcoding methods generally used to serve heterogeneous receivers. The same method can be used for archiving videos, thereby providing storage efficiency.

FIG. 4 illustrates an exemplary flow diagram of a preferred embodiment of the present invention. Each component shown in this figure will now be described.

Streaming server 100 builds and streams media information to clients according to user preferences and receiver capabilities. It does not perform any transcoding operations, but simply assembles access units into streams according to the control information from the broadcaster 200. It also gathers client feedback in order to estimate the status of the transmission channels and forwards the information to the broadcaster 200.

Client feedback component 110 gathers client feedback, in terms of available bandwidth or transmission quality, and forward updates to the broadcaster 200.

Stream builder 120 streams media information to the clients, based on the client characteristics. The stream builder assembles media streams with the access units sent by the broadcaster 200, according to the control information embedded in the stream by the broadcaster 200.

Broadcaster 200 generates possibly several compressed descriptions of the information source, in order to allow the streaming server to efficiently and adaptively serve clients with different characteristics and requirements, based on the characteristics of the receivers, and the live uncompressed sequence. It also minimizes the resource consumption in terms of storage and bandwidth requirement.

Optimization engine 210 optimally determines the number of client groups (i.e., channels), the number of compressed descriptions in each time interval, and the coding parameters of these descriptions, based on aggregate feedback from the clients forwarded by the streaming server. The optimization minimizes the resources consumption, while ensuring an good final quality to all the clients. In general, compressed descriptions which are similar up to a certain threshold measured in comparing the decoded frames are simply pruned or discarded, and only one version is kept for transmission. The value of the pruning threshold is determined by the resources available, in terms of bandwidth and/or storage. It then sends the encoding strategy to the encoder 220.

Multiple output encoder 220 encodes the uncompressed live stream into several descriptions, according to the encoding strategy determined by the optimization engine 210. The outputs of the encoder are not necessarily continuous streams, but may consist of chunks of streams instead. The stream builder 120 then is responsible for forming continuous streams with these building blocks, according to the control information sent by the broadcaster 200.

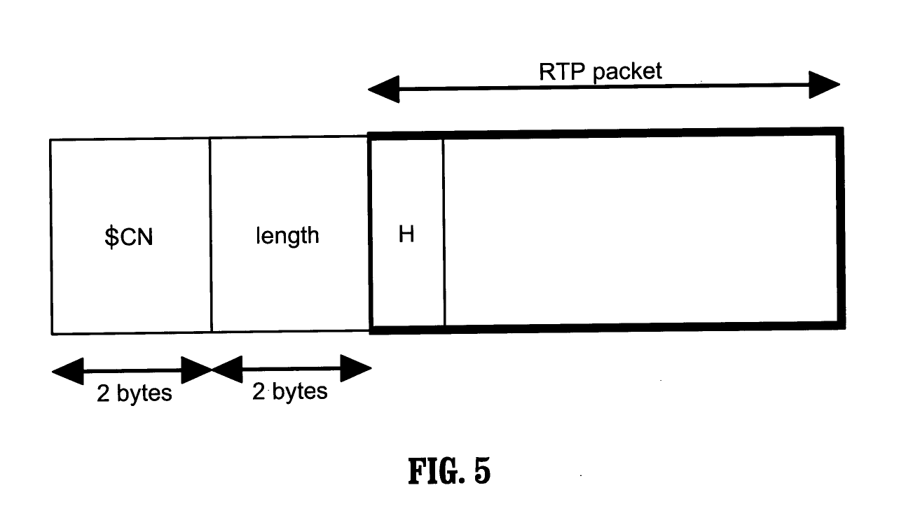

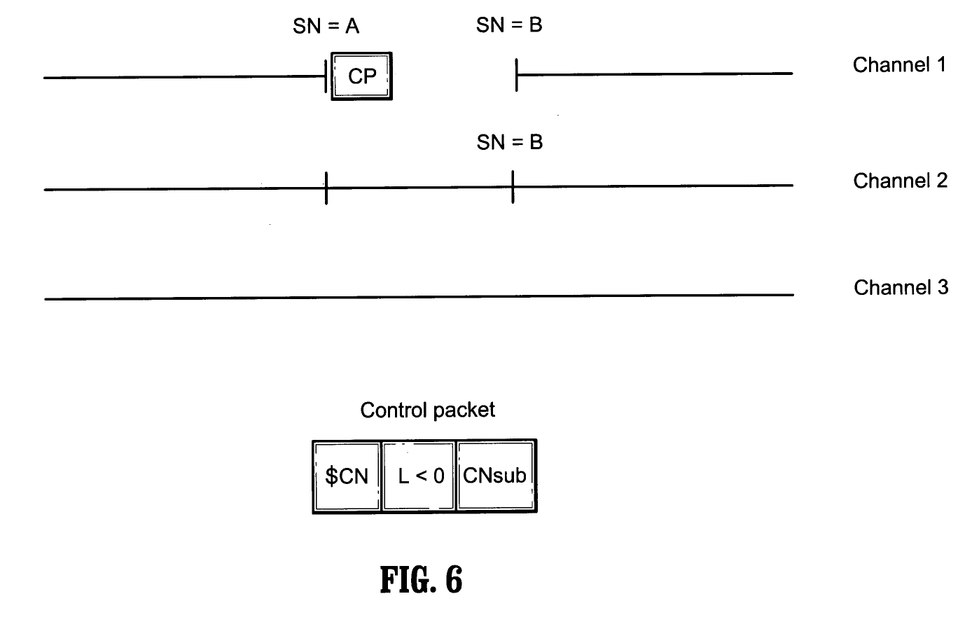

Multiplexer 230 multiplexes the packetized description in a unicast-type connection to the streaming server. It sends the different descriptions in the increasing number of their decoding time-stamps. If different descriptions have the same time-stamps, it sends all these descriptions before sending descriptions with larger decoding time-stamps. If one description is missing in a given channel, it replaces it by a control packet, where the address of the substitute description is given in the payload. FIG. 5 shows an example of packet generated by a TCP multiplexer, where CN is the channel number and length is the total length of the TCP frame. FIG. 6 illustrates an example of control packet generation. Part of the channel 1 has been pruned, and a control packet is inserted in place of the discarded media information. The control packet has a negative length, and the payload is replaced by the channel number where the media information has to be picked to form a continuous stream.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A method for streaming media information via a network to heterogeneous clients, comprising the steps of:
receiving media information;
determining an encoding strategy for the media information;
encoding a plurality of descriptions of the media information according to the encoding strategy; and
transmitting the descriptions along with control information.

2. The method of claim 1, wherein the step of determining an encoding strategy includes determining characteristics of the descriptions at least in part based on transmission rate and encoding mode.

3. The method of claim 1, wherein the descriptions include one or more data unit.

4. The method of claim 3, further comprising implementing a pruning algorithm to determine which data units are to be discarded.

5. The method of claim 4, wherein a data unit for a first description is discarded based on a correspondence with a data unit for a second description.

6. The method of claim 1, further comprising the steps of:
receiving the descriptions and the control information; and
assembling media streams from the descriptions using the control information.

7. The method of claim 6, wherein quality of service perceived by clients is maintained.

8. The method of claim 1, wherein the descriptions are multiplexed.

9. The method of claim 8, wherein the multiplexed descriptions are scheduled for transmission according to presentation deadlines.

10. The method of claim 1, wherein the media information includes one or more of a video signal and an audio signal.

11. The method of claim 1, wherein one or more client subscribe to one or more multicast group.

12. A system for streaming media information via a network to heterogeneous clients, comprising:
a broadcaster that receives media information, determines an encoding strategy for the media information, encodes a plurality of descriptions of the media information according to the encoding strategy, and transmits the descriptions along with control information.

13. The system of claim 12, wherein the broadcaster determines the broadcasting strategy by determining characteristics of the descriptions based at least in part on transmission rate and encoding mode information.

14. The system of claim 12, wherein the descriptions include one or more data unit.

15. The system of claim 14, wherein a pruning algorithm is implemented to determine which data units are to be discarded.

16. The system of claim 15, wherein a data unit for a first description is discarded based on a correspondence with a data unit for a second description.

17. The system of claim 12, wherein the broadcaster includes a multiplexer for multiplexing the descriptions.

18. The system of claim 17, wherein the multiplexed descriptions are scheduled for transmission according to presentation deadlines.

19. The system of claim 12, wherein the media information includes one or more of a video signal and an audio signal.

20. The system of claim 12, wherein one or more client subscribe to one or more multicast group.

21. The system of claim 12, further comprising a streaming server for receiving the descriptions and the control information and assembling media streams from the descriptions using the control information.

22. The system of claim 21, wherein quality of service perceived by clients is maintained.

23. A program storage device readable by a machine, tangibly embodying a program of instructions executable on the machine to perform method steps for streaming media information via a network to heterogeneous clients, the method steps comprising:
receiving media information;
determining an encoding strategy for the media information;
encoding a plurality of descriptions of the media information, according to the encoding strategy; and
transmitting the descriptions along with control information.

24. The method of claim 1 wherein the media information is indicative of live media.

25. The method of claim 1 wherein the transmitted descriptions collectively correspond to thinned media.

26. The method of claim 6 wherein at least one of the assembled media streams comprises thinned media.

27. The system of claim 12 wherein said media information is indicative of live media.

28. The system of claim 12 wherein the transmitted descriptions collectively correspond to thinned media.

29. The system of claim 21 wherein at least one of the assembled media streams comprises thinned media.

30. A method for thinning media information, comprising the steps of:
receiving media information;
determining an encoding strategy for the media information;
encoding a plurality of descriptions of the media information according to the encoding strategy; and
assembling media streams from the descriptions wherein at least one of the assembled media streams comprises thinned media.

31. A method as defined in claim 30, further comprising transmitting at least one assembled media stream comprising thinned media to heterogeneous clients.

32. A method as defined in claim 31 wherein the thinned media is transmitted via streaming over a network.

33. A method as defined in claim 31 wherein each of the heterogeneous clients receives a media stream compatible with its respective storage and bandwidth requirements.
